(19) United States
(12) Patent Application Publication
(10) Pub. No.: US 2010/0161395 A1
(43) Pub. Date: Jun. 24, 2010

(54) System and Method for Rendering Advertisements

(76) Inventors: John Edgar Salsman, III, Lexington, KY (US); Timothy S. Seevers, Lexington, KY (US); Joel Stinson Young, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/342,639

(22) Filed: Dec. 23, 2008

(51) Int. Cl. G06Q 90/00; G06F 3/12

(52) U.S. Cl. 705/14.4; 358/1.15; 358/1.13

(57) ABSTRACT

A method, computer program product, and print driver for receiving an indication, on a computing device, of a print job to be printed on a printing device. One or more advertisements are rendered on the computing device. The print job is provided to the printing device.

### TECHNICAL FIELD

This disclosure relates to printing systems and, more particularly, to printing systems that render advertisements in response to printing requests.

### BACKGROUND

Advertisements have been used to offset operational costs for various services and products. For example, non-cable television channels use commercials to offset the cost of producing and broadcasting various television shows. Print publications (e.g. magazines and newspapers) utilize advertisements to reduce the cost of these printed publications.

With the Internet age has come a plethora of new technologies, services, and business models. Not the least of which is the Internet-advertising model, where virtually all revenue is generated by advertisements. For example, Google, Inc. has led the way in the Internet-advertising model by not only providing advertisements alongside of their search results but by tuning the advertisements to be relevant to the search results and, ultimately, to the consumer that did the search.

### SUMMARY OF DISCLOSURE

In a first implementation, a method includes receiving an indication, on a computing device, of a print job to be printed on a printing device. One or more advertisements are rendered on the computing device. The print job is provided to the printing device.

One or more of the following features may be included. One or more advertisements may be obtained from a remote source. The remote source may be a remote advertisement server.

Obtaining one or more advertisements from a remote source may include obtaining one or more advertisements from the remote source in response to receiving the indication. Obtaining one or more advertisements from a remote source may include obtaining one or more advertisements from the remote source prior to receiving the indication. The one or more advertisements may be chosen from the group consisting of a still image advertisement and a video advertisement.

In another implementation, a computer program product resides on a computer readable medium that has a plurality of instructions stored on it. When executed by a processor, the instructions cause the processor to perform operations including receiving an indication, on a computing device, of a print job to be printed on a printing device. One or more advertisements are rendered on the computing device. The print job is provided to the printing device.

One or more of the following features may be included. One or more advertisements may be obtained from a remote source. The remote source may be a remote advertisement server.

Obtaining one or more advertisements from a remote source may include obtaining one or more advertisements from the remote source in response to receiving the indication. Obtaining one or more advertisements from a remote source may include obtaining one or more advertisements from the remote source prior to receiving the indication. The one or more advertisements may be chosen from the group consisting of a still image advertisement and a video advertisement.

In another implementation, a print driver is configured to perform operations including receiving an indication, on a computing device, of a print job to be printed on a printing device. One or more advertisements are rendered on the computing device. The print job is provided to the printing device.

One or more of the following features may be included. One or more advertisements may be obtained from a remote source. The remote source may be a remote advertisement server.

Obtaining one or more advertisements from a remote source may include obtaining one or more advertisements from the remote source in response to receiving the indication. Obtaining one or more advertisements from a remote source may include obtaining one or more advertisements from the remote source prior to receiving the indication. The one or more advertisements may be chosen from the group consisting of a still image advertisement and a video advertisement.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printer advertisement process executed by a computing device coupled to a distributed computing network;

FIG. 2 is a flowchart of the printer advertisement process of FIG. 1; and

FIG. 3 is a diagrammatic view of advertisements rendered by the printer advertisement process of FIG. 1.

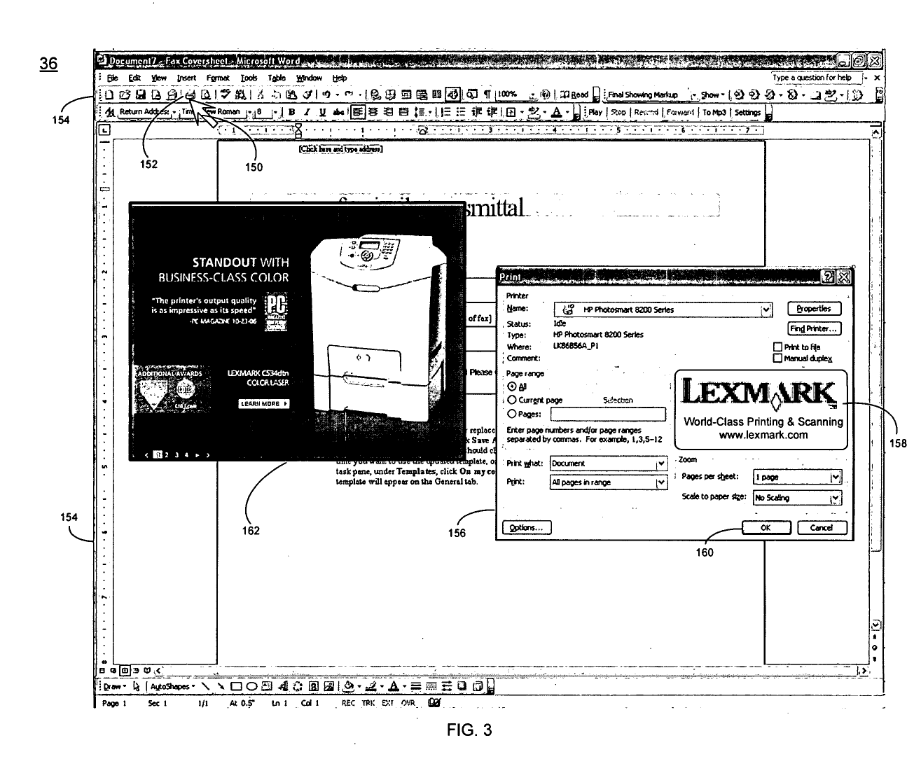

Like reference symbols in the various drawings indicate like elements.

### DETAILED DESCRIPTION OF THE PREFERRED EMBODIMENTS

### System Overview:

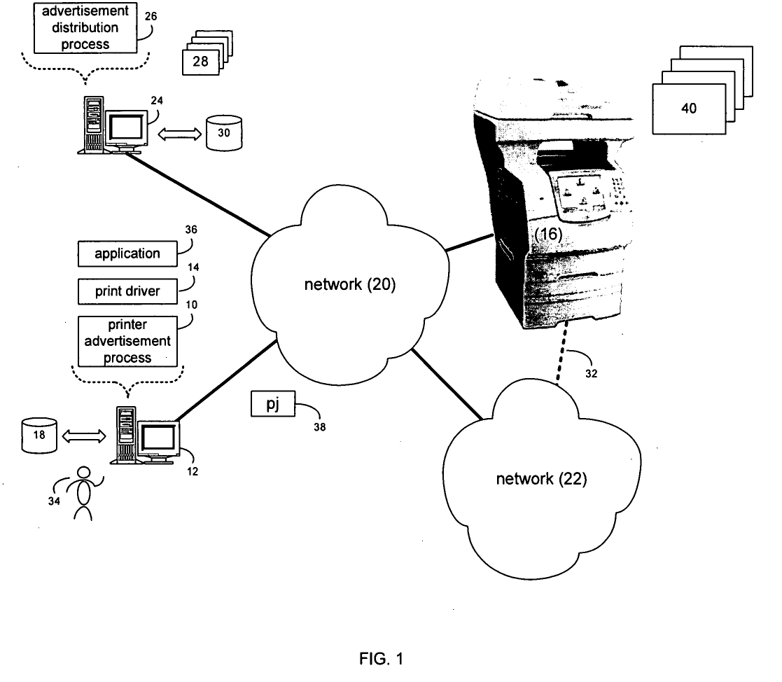

Referring to FIG. 1, there is shown a printer advertisement process 10 that may reside on and may be executed by a computing device (e.g., computing device 12). Printer advertisement process 10 may be a stand alone application or may be incorporated into another application, such as print driver 14. As will be discussed below in greater detail, printer advertisement process 10 may receive an indication, on e.g., computing device 12, of a print job to be printed on a printing device (e.g., printing device 16). One or more advertisements may be rendered on the computing device before (or while) the print job is being provided to the printing device, thus reducing the cost of ownership of printing device 16. For example, the cost of purchasing printing device 16 may be reduced and/or the cost of consumables for printing device 16 may be reduced.

The instruction sets and subroutines of printer advertisement process 10, which may be stored on storage device 18 coupled to computing device 12, may be executed by one or more processors (not shown) and one or more memory architectures (not shown) incorporated into computing device 12. Storage device 18 may be an internal storage device included within computing device 12. Examples of storage device 18 may include but are not limited to: a hard disk drive; a tape drive; an optical drive; a RAID array; a random access memory; a read-only memory; a compact flash (CF) storage device, a secure digital (SD) storage device, and a memory stick storage device. Computing device 12 may execute an operating system, examples of which may include but are not limited to a Windows™ based operating system, a Mac™ based operating system, a Unix™ based operating system and a Linux™ based operating system.

Computing device 12 and/or printing device 16 may be coupled to network 20 (e.g., the Internet or a local area network). Examples of computing device 12 may include but are not limited to a desktop computer, a laptop computer, a notebook computer, a personal digital assistant, or a data enabled cellular telephone. Examples of printing device 16 may include but are not limited to an inkjet printing system, a laser printing system, and a multifunction printing system. Examples of such a multifunction printing system may include but are not limited to a Lexmark X850e and a Lexmark X646e, both of which are available from Lexmark International of Lexington, Ky.

Network 20 may be coupled to one or more secondary networks (e.g., network 22), examples of which may include but are not limited to: a local area network; a wide area network; or an intranet, for example.

Server computer 24 may be an advertisement server and may execute advertisement distribution process 26 that may distribute advertisements 28 to e.g., devices executing printer advertisement process 10 (e.g. computing device 12). Examples of server computer 24 may include but are not limited to a personal computer, a server computer, a series of server computers, a mini computer, and a mainframe computer. The instruction sets and subroutines of advertisement distribution process 26, which may be stored on storage device 30 coupled to server computer 24 may be executed by one or more processors (not shown) and one or more memory architectures (not shown) incorporated into server computer 24. Server computer 24 may be a web server (or a series of servers) running a network operating system, examples of which may include but are not limited to: Microsoft Windows XP Server™; Novell Netware™; or Redhat Linux™, for example.

Computing device 12 may communicate with server computer 24 and/or printing device 16 via network 20 and/or network 22. Further, printing device 16 may be coupled to network 20 through secondary network 22, as illustrated with phantom link line 32.

### Printer Advertisement Process:

As discussed above, printer advertisement process 10 may receive an indication, on e.g., computing device 12, of a print job to be printed on a printing device (e.g., printing device 16). One or more advertisements may be rendered on the computing device before (or while) the print job is being provided to the printing device.

While using computing device 12, user 34 may execute one or more applications 36 on computing device 12. An example of application 36 may include but is not limited to a word processing application, a spreadsheet application, a photo editing application, a graphics application, or an e-mail application. While using application 36, user 34 may wish to execute one or more print functions. Examples of a print function may include but are not limited to a screen print function, a document print function, and image print function, or a photo print function.

Typically, when initiating a print function, print driver 14 may be utilized to convert the data being manipulated by application 36 into a format that is recognizable/usable by printing device 16. Once print driver 14 makes such a data conversion, the appropriate data signals (i.e. print job 38) may be transmitted to printing device 16 via network 20 and/or network 22. Upon receiving print job 38, printing device 16 may process print job 38 and may produce one or more printed pages 40.

While computing device 12 is shown to be coupled to printing device 16 via network 20 and/or network 22, this is for illustrative purposes only and is not intended to be a limitation of this disclosure, as other configurations are possible. For example, computing device 12 may be directly coupled to printing device 16 via a universal serial bus (i.e. USB) cable or a standard printer cable.

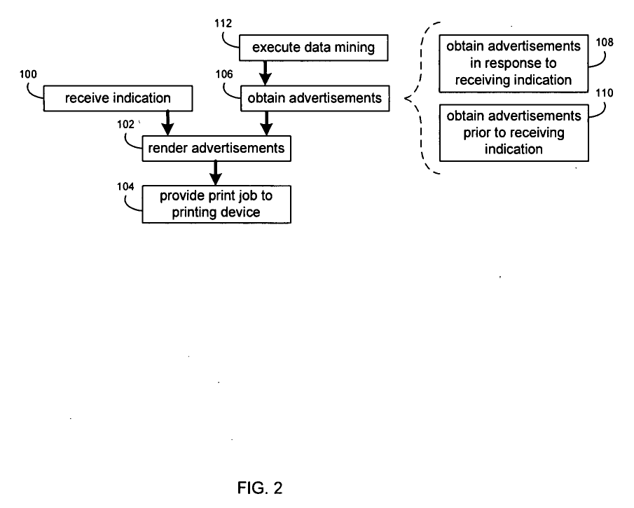

Referring also to FIGS. 2 & 3, when user 34 initiates the above-described print function, printer advertisement process 10 may receive 100 an indication (on computing device 12) that such a print function was initiated and, therefore, a print job is going to be printed on printing device 16. For example, printer advertisement process 10 may monitor print driver 14 to determine whenever an application (e.g. application 36) calls print driver 14 and initiates such a print function. As discussed above, printer advertisement process 10 may be a stand alone application or may be incorporated into print driver 14. In response to receiving 100 such an indication, printer advertisement process 10 may render 102 one or more advertisements on computing device 12. The advertisements rendered 102 by printer advertisement process 10 may be obtained from a remote source, such as advertisement server 24.

Assume for illustrative purposes that user 34 is using application 36 (e.g. a word processing application) to type a facsimile coversheet and user 34 wishes to print a copy of that facsimile coversheet. User 34 may, using on-screen pointer 150 (controllable by a pointing device such as a mouse; not shown) select “print” icon 152 from toolbar 154 of application 36. Upon selecting icon 152, the print function of application 36 may be initiated.

As discussed above, printer advertisement process 10 may monitor print driver 14 to determine whenever an application (e.g. application 36) calls print driver 14 and initiates such a print function. Accordingly, upon user 34 selecting icon 152, print driver 14 may be called and printer advertisement process 10 may receive 100 such an indication.

As discussed above, in response to receiving 100 an indication of a print job to be printed, printer advertisement process 10 may render 102 one or more advertisements on computing device 12. The manner in which printer advertisement process 10 renders 102 advertisements may vary depending on the manner in which printer advertisement process 10 is implemented. For example, printer advertisement process 10 may insert a still image advertisement or a video advertisement into an existing pop-up window utilized by application 36.

For example,upon user 34 selecting icon 152, application 36 may render “print options” window 156 that may allow user 34 to select various printing options (e.g. “print range” and “zoom level”). Accordingly, printer advertisement process 10 may insert a still image advertisement or a video advertisement into “print options” window 156. For example, “print options” window 156 is shown to include a Lexmark™ advertisement. Therefore, printer advertisement process 10 may define a portion of “print options” window 156 as “advertisement space” 158, in that when a print function is initiated by e.g., user 34 and printer advertisement process 10 receives 100 an indication of the initiation of such a print function, printer advertisement process 10 may render 102 an advertisement within “advertisement space 158”.

While “print options” window 156 is shown to include a still image advertisement, this is for illustrative purposes only and is not intended to be a limitation of this disclosure. For example, printer advertisement process 10 may populate “advertisement space” 158 with a video advertisement.

To enhance the likelihood that user 34 will read/watch the advertisement rendered 102 within “advertisement space” 158, printer advertisement process 10 may not allow user 34 to select “print” button 160 until e.g. a video advertisement has been completely rendered or a still image advertisement has been displayed within “print options” window 156 for a defined period of time (e.g. 10 seconds). Only once the rendering 102 has been completed (or after the passage of a defined period of time) will printer advertisement process 10 allow user 34 to select “print” button 160. Once user 34 selects “print” button 160, print job 38 may be provided 104 to printing device 16.

While printer advertisement process 10 is described above as defining a portion of “print options” window 156 to include “advertisement space” 158, this is for illustrative purposes only and is not intended to be a limitation of this disclosure. For example, the advertisements rendered 102 by printer advertisement process 10 may be rendered in a separate advertisement window (e.g. advertisement window 162) apart from “print options” window 156. As with “advertisement space” 158, advertisement window 162 may allow for the rendering 102 of various types of advertisements, examples of which may include but are not limited to still image advertisements and video advertisements. As with “advertisement space” 158, printer advertisement process 10 may render “print” button 160 inoperable until e.g. a video advertisement has been completely rendered or a still image advertisement has been displayed within advertisement window 162 for a defined period of time (e.g. 10 seconds).

While printer advertisement processed 10 is described above as requiring the advertisement to be completely rendered (or display for a defined period of time) prior to allowing user 34 to e.g. select “print” button 160, this is for illustrative purposes only and is not intended to be a limitation of this disclosure. Specifically, printer advertisement process 10 may be configured so that the advertisements are not rendered 102 until after user 34 selects the “print” button. Alternatively, printer advertisement process 10 may be configured so that the advertisement is completely rendered (or displayed for a defined period of time) prior to the rendering of “print options” window 156.

As discussed above, the advertisements rendered 102 by printer advertisement process 10 may be obtained from a remote source, such as advertisement server 24. When obtaining 106 the advertisements, the advertisements may be obtained 108 from the remote source (e.g., advertisement server 24) in response to receiving 100 the indication that the print function was initiated. Accordingly, whenever a print function is initiated (e.g. by selecting print icon 152) and a corresponding indication is received 102, printer advertisement process 10 may access advertisement server 24 to obtain 108 an advertisement (e.g. a still image advertisement or a video advertisement) for rendering 102 within e.g. “advertisement space” 158 or advertisement window 162.

Alternatively, when obtaining 106 the advertisements, the advertisements may be obtained 110 from the remote source (e.g., advertisement server 24) prior to receiving 100 the indication that the print function was initiated. Accordingly, advertisement process 10 may be configured to proactively obtain 110 advertisements from advertisement server 24 prior to them being needed. For example, printer advertisement process 10 may access advertisement server 24 on a periodic basis (e.g. weekly) to obtain a plurality of advertisements that may subsequently be rendered 102 upon the appropriate indication being received 100.

Prior to obtaining 106 the advertisements stored on e.g. advertisement server computer 24, printer advertisement process 10 may perform 112 a data mining process on the content to be printed so that e.g. the advertisements obtained 106 may be directed towards the topic of the content to be printed. For example, if the above-described facsimile coversheet concerns a trip to Walt Disney World in Orlando, Fla., printer advertisement process 10 may request from advertisement server computer 24 advertisements concerning e.g. Walt Disney World and/or Orlando, Fla. Therefore, the advertisements obtained 106 may be directed towards e.g. hotels within Orlando, Fla., things to do within Walt Disney World, and sites to see around Walt Disney World.

A number of implementations have been described. Nevertheless, it will be understood that various modifications may be made. Accordingly, other implementations are within the scope of the following claims.

What is claimed is:

1. A method comprising:
receiving an indication, on a computing device, of a print job to be printed on a printing device;
rendering one or more advertisements on the computing device; and
providing the print job to the printing device.

2. The method of claim 1 further comprising:
obtaining one or more advertisements from a remote source.

3 The method of claim 2 wherein the remote source is a remote advertisement server.

4. The method of claim 2 wherein obtaining one or more advertisements from a remote source includes:
obtaining one or more advertisements from the remote source in response to receiving the indication.

5. The method of claim 2 wherein obtaining one or more advertisements from a remote source includes:
obtaining one or more advertisements from the remote source prior to receiving the indication.

6. The method of claim 1 wherein the one or more advertisements are chosen from the group consisting of: a still image advertisement; and a video advertisement.

7. A computer program product residing on a computer readable medium having a plurality of instructions stored thereon which, when executed by a processor, cause the processor to perform operations comprising:
receiving an indication, on a computing device, of a print job to be printed on a printing device;
rendering one or more advertisements on the computing device; and
providing the print job to the printing device.

8. The computer program product of claim 7 further comprising instructions for:
obtaining one or more advertisements from a remote source.

9. The computer program product of claim 8 wherein the remote source is a remote advertisement server.

10. The computer program product of claim 8 wherein the instructions for obtaining one or more advertisements from a remote source include instructions for:
obtaining one or more advertisements from the remote source in response to receiving the indication.

11. The computer program product of claim 8 wherein the instructions for obtaining one or more advertisements from a remote source include instructions for:
obtaining one or more advertisements from the remote source prior to receiving the indication.

12. The computer program product of claim 7 wherein the one or more advertisements are chosen from the group consisting of: a still image advertisement; and a video advertisement.

13. A print driver configured to perform operations comprising:
receiving an indication, on a computing device, of a print job to be printed on a printing device;
rendering one or more advertisements on the computing device; and
providing the print job to the printing device.

14. The print driver of claim 13, wherein the print driver is further configured to perform operations comprising:
obtaining one or more advertisements from a remote source.

15. The print driver of claim 14 wherein the remote source is a remote advertisement server.

16. The print driver of claim 14 wherein obtaining one or more advertisements from a remote source includes:
obtaining one or more advertisements from the remote source in response to receiving the indication.

17. The print driver of claim 14 wherein obtaining one or more advertisements from a remote source includes:
obtaining one or more advertisements from the remote source prior to receiving the indication.

18. The print driver of claim 13 wherein the one or more advertisements are chosen from the group consisting of: a still image advertisement; and a video advertisement.
